(19) United States
(12) Patent Application Publication
(10) Pub. No.: US 2007/0212449 A1
(43) Pub. Date: Sep. 13, 2007

(54) Reduction of the titratable acidity and the prevention of tooth and other bone degeneration

(76) Inventors: Abulkalam M. Shamsuddin, Lutherville, MD (US); Joseph A. von Fraunhofer, Parkton, MD (US)

Correspondence Address: BINGHAM MCCUTCHEN LLP, Three Embarcadero Center, San Francisco, CA, 94111-4067, US

(21) Appl. No.: 11/712,512

(22) Filed: Mar. 1, 2007

Related U.S. Application Data
(60) Provisional application No. 60/778,108, filed on Mar. 2, 2006.

(51) Int. Cl. A23L 1/30

(52) U.S. Cl. 426/74

(57) ABSTRACT

The present invention provides compositions of inositol and derivatives and their salts and related compounds which reduce titratable acidity and the erosive potential of a variety of beverages and foodstuffs. Further, as a result of its protective action towards acid attack on dental enamel (hydroxyapatite), its addition to foodstuffs has a protective action towards the hard dental tissues. The compositions also provide protection against other metabolic/degenerative diseases of bones such as osteoporosis. The present invention further provides methods for preventing dental decay and bone degeneration.

### FIELD OF INVENTION

This invention relates to methods and compositions for reducing the titratable acidity (TA) of foodstuffs and beverages as well as methods and compositions used for treating and preventing decay, erosion, and degeneration of teeth and other bones.

### BACKGROUND OF THE INVENTION

Soft drinks are a significantly large business in the United States, with sales rapidly approaching $64 billion per year and an annual growth rate of 30%. Over the last 50 years, the consumption of soft drinks (including carbonated beverages, fruit juices, and sport drinks) in the U.S. has increased 500%.

Approximately 28% of beverages consumed by Americans are carbonated soft drinks; approximately 1.5-2.0 12-ounce cans are consumed per day on average (equaling approximately 54 gallons per year). Reduced-calorie soft drinks accounted for 24% of popular drink sales, an increase of 16% over a 27-year period.

The literature contains numerous references to the increasing prevalence of dental erosion, the irreversible loss of hard tissue due to dissolution or chelation; the literature indicates that this increase is related to frequent or continuous soft drink consumption. Children and adolescents have reported the greatest increase in soft drink consumption over the past two decades; this trend may be due in part to the prevalence of soft drink vending machines in schools. However, these findings are comparable to soft drink consumption and associated prevalence of dental erosion reported for the United Kingdom, Ireland, Iceland, Saudi Arabia, and New Zealand.

Erosion causes significant damage to dental enamel. The underlying acidity of beverages is the primary factor in the dental erosion resulting from their consumption. The literature indicates that the total or titratable acid level determines the availability for interaction between the hydrogen ion and the tooth surface, rather than beverage pH alone. The optimal pH of saliva is 6.5-7.5; the threshold pH level for the development of dental caries is 5.5. The oral cavity may recover when the pH drops below 5.5 but enamel demoralization tends to be more rapid following prolonged exposure to lowered pH values or frequent cycling between the optimal pH to below the threshold value. Carbonation per se is not an important factor in dental erosion.

Erosion from beverages is determined not only by the exposure time and temperature but also by the type of acid, its calcium chelating properties, and the beverage's propensity for retention on enamel. Most soft drinks contain one or more food acidulants; phosphoric and citric acid are most common but other organic acids (such as malic and tartaric acids) also may be present. These poly-basic acids can be very erosive to dental enamel because of their ability to chelate calcium. In addition, polybasic acids are highly effective buffers and can maintain the pH below the threshold value even with marked dilution.

Although enamel erosion from soft drink consumption has been addressed frequently in the literature, there appears to be limited data concerning the relative aggressiveness of the very wide variety of soft drinks available to the average consumer. Non-cola drinks and canned iced tea were far more aggressive toward dental enamel than cola-based drinks, an effect that could not be ascribed simply to the soft drink's pH. Since the pH range for most beverages is 2.4-3.4 (that is, well below the 5.5 threshold pH for dental caries), the enhanced enamel dissolution most likely is due to the additives within non-cola beverages that produce the desired palatability.

The rapid increase in energy or sports drink consumption was noted above. One study indicated that sports drinks have a high demineralization potential, while another study found no association between dental erosion and the use of sports drinks.

A. Tooth Decay

It is well-established that most of the popular beverages contain various acidulants as flavor-enhancers and the scientific literature clearly indicates that these beverages can attack hydroxyapatite, the principal component of the dental hard tissues (dental enamel, dentin and cementum). A recent report has demonstrated that citrus-containing beverages cause more severe damage to dental enamel than Cola-type beverages, as demonstrated by enamel dissolution rates shown in FIG. 1.

The greater rate of enamel dissolution in citrus-containing beverages may be ascribed to the buffering capacity of citric acid (and similar low molecular weight organic acids) present in the beverage. As a result, the primary factor in dental erosion by beverages is the potential acidity, that is, the total or titratable acidity. Since the titratable acidity determines the total number of acid molecules (both protonated and unprotonated) available for interaction with the tooth surface rather than the beverage pH, the total acid content may be a more accurate predictor of erosive potential. There are also indications that the citric acid present in such soft drinks can have adverse effects on dental restorative materials as well as elastomeric chains used for orthodontic correction of malocclusions

B. Degeneration of Other Bones

Osteoporosis is a generalized and progressive reduction in bone mass per unit of bone volume characterized by increased bone resorption and normal or diminished bone formation resulting in weak and fragile bone with increased risks of fractures of hip, wrist and spine.

In the United States, nearly 10 million people already have osteoporosis. Another 18 million people have low bone mass that places them at an increased risk for developing osteoporosis. Eighty percent of those with osteoporosis are women. Of people older than 50 years, 1 in 2 women and 1 in 8 men are predicted to have an osteoporosis-related fracture in their lifetime.

Osteoporosis-induced fractures cause a great burden to society. Hip fractures are the most serious resulting in hospitalization almost as a routine and are fatal in about 20% of the time. About one-half of the patients with hip fracture are permanently disabled and the rate of fracture increases rapidly with age. The lifetime risk of fracture in 50 year-old women is about 40%, a figure not too different than that for coronary heart disease. The lifetime risk of a 50-year-old woman for dying from hip fracture is 2.8%, equal to the risk of dying from breast cancer!

In 1990, there were 1.7 million hip fractures alone worldwide; with changes in population demographics, this figure is expected to rise to 6 million by 2050; this is the most common bone disease a physician sees in his/her practice. In the year 2000, the number of osteoporotic fractures was estimated at 3.79 million in Europe, of which 0.89 million were hip fractures (179,000 hip fractures in men and 711,000 in women). The total direct cost was C31.7 billion which is projected to increase to [symbol] 76.7 billion in 2050 based on the expected changes in the demography of Europe! What about the US? Estimate for the year 2005 in total direct cost of fractures secondary to osteoporosis in US is $17 billion.

While bone may appear deceptively lifeless, it is a living tissue, for it is being continually broken down or resorbed by cells called osteoclasts, and at the same time it is being built or reconstructed by cells called osteoblasts. It is the balance between these cells that determines whether we gain or lose bone. During childhood and adolescence, bone formation is dominant. The bone length and girth increase with age, ending at early adulthood when peak bone mass is attained. In males after the age of 20, bone resorption becomes predominant, and bone mineral content declines by about 4% per decade. Females on the other hand tend to maintain peak mineral content until menopause. After that time, the bone mineral content declines at a rate of about 15% per decade. Thus, women tend to lose. the bone mineral at a very accelerated rate after menopause.

C. IP₆ & Inositol

Both inositol and IP₆ are antioxidants that are important in cancer control by normalizing the excessive and uncontrolled rate of cell proliferation and by boosting the natural killer (NK) cell activity. See U.S. Pat. No. 5,082,833, which is incorporated by reference for all purposes. In addition, a combined use of IP₆ and inositol demonstrates significant synergistic benefits for human health, such as preventing pathological calcification and kidney stone formation, lowering elevated serum cholesterol, and reducing pathological platelet activity. Orally administered IP₆ and inositol are rapidly absorbed in the stomach and quickly distributed to various tissues, organs, and body fluids including the urine and saliva as inositol, IP₆ and other lower phosphorylated forms of IP₆ such as IP_{5,4,3,2,1}. IP₆ can also be absorbed through skin as quickly as in the stomach.

### SUMMARY OF THE INVENTION

The present invention generally relates to a method comprising the steps of depositing an inositol phosphate composition into a foodstuff or beverage, thereby decreasing the titratable acidity of said foodstuff or beverage. The present invention also generally relates to a composition comprising inositol hexaphosphate and inositol, wherein the combined amount of inositol hexaphosphate and inositol is sufficient to prevent or slow progression of dental erosion or osteoporosis in a subject in need of such treatment. The present invention further generally relates to a method comprising administering to a mammal a pharmaceutical composition comprising inositol hexaphosphate with or without inositol in an amount sufficient to prevent, slow the progression or inhibit osteoporosis.

### BRIEF DESCRIPTION OF DRAWINGS

FIG. 1 shows that citrus-containing beverages cause more severe damage to dental enamel than Cola-type beverages, as demonstrated by enamel dissolution rates.

FIG. 2 shows the chemical composition of inositol. (Structure of the cyclic polyalcohol Inositol (cis-1,2,3,5-trans-4,6-cyclohexanehexol)).

FIG. 3 shows the weight loss of dental enamel in soft drinks and beverage pH.

FIG. 4 shows beverage pH and enamel dissolution.

FIG. 5 shows that there is a very strong correlation between titratable acidity and enamel dissolution.

FIG. 6 shows that there is a very strong correlation between titratable acidity and enamel dissolution.

FIG. 7 shows the effect of phytic acid on reducing enamel erosivity in a Mountain Dew beverage.

FIG. 8 shows the effect of phytic acid addition on reducing enamel erosivity in a Red Bull beverage.

FIG. 9 shows the effect of phytic acid additions on titrable acidity by showing the reduction in titratable acidity for Fresca (0.5% addition), Sprite (0.5% addition) and Mountain Dew (1.0% addition).

FIG. 10 shows the reduction in enamel dissolution by Mountain Dew and 5% lemon juice by addition of 1% phytic acid.

### DETAILED DESCRIPTION OF THE INVENTION

In the invention presented below, the inventors of the present application demonstrate that intositol hexaphosphate (IP₆), and/or other inositol derivatives such as inositol monophosphate (IP₁), inositol diphosphate (IP₂), inositol triphosphate (IP₃), inositol tertaphosphate (IP₄), and inositol pentaphosphate (IP₅) are capable of reducing the titratable acidity, which is the main parameter that causes erosion of hydroxyapatite (i.e., dental enamel). IP₆ and inositol have been demonstrated to be able to rapidly be absorbed through the gastric and other mucous membranes as well as skin, and distributed to various organs and body fluids including saliva. Accordingly, inositol and its salts (sodium, potassium, calcium, magnesium and calcium-magnesium) and derivatives may be added to foodstuffs and beverages to reduce the titratable acidity and applications such as to prevent and treat dental decay, tooth erosion, and bone degeneration. Foodstuffs and beverages are defined as any substance used by humans or mammals for food, drink, confectionery or condiment. Further, a beverage may be a liquid substance or composition including, but not limited to the following: water, soft drinks including cola-based, fruit-based and citrus-based varieties, root beer, ginger ale, fruit and vegetable juices, alcoholic drinks, carbonated drinks, caffeinated drinks, dairy products, nutrient-enriched drinks, sports drinks, energy drinks, and diet or reduced calorie drinks. Examples of beverages include those marketed under the following trade names: A&W Root Beer (a carbonated beverage marketed under the name A&W Root Beer), Bart's Root Beer (a carbonated beverage marketed under the name Bart's Root Beer), Canada Dry Ginger Ale (a carbonated beverage marketed under the name Canada Dry Ginger Ale), Coca-Cola (a carbonated beverage marketed under the name Coca-Cola), Diet Coke (a carbonated beverage marketed under the name Diet Coke), Pepsi (a carbonated beverage marketed under the name Pepsi), Diet Pepsi (a carbonated beverage marketed under the name Diet Pepsi), Dr. Pepper (a carbonated beverage marketed under the name Dr. Pepper), Fresca (a carbonated beverage marketed under the name Fresca), Gatorade (a non-carbonated beverage marketed under the name Gatorade), Mountain Dew (a carbonated beverage marketed under the name Mountain Dew), Diet Mountain Dew (a carbonated beverage marketed under the name Diet Mountain Dew), Red Bull (a carbonated beverage marketed under the name Red Bull), Sprite (a carbonated beverage marketed under the name Sprite), Diet Sprite (a carbonated beverage marketed under the name diet Sprite), as well as any carbonated or non-carbonated beverage or liquid. A “foodstuff” may be defined as any substance, material or nutrient that may be consumed or used in the preparation of a composition for consumption.

In one embodiment of the invention, the inositol phosphate composition may comprise inositol phosphates having 1-6 phosphate groups. In another embodiment of the invention, the inositol phosphate composition may comprises an inositol phosphate salt. In another embodiment of the invention, the inositol phosphate salt may be selected from a group consisting essentially of: potassium, calcium, magnesium, calcium-magnesium, and sodium inositol phosphate salts. In another embodiment of the invention, the inositol phosphate composition may be deposited into said foodstuff or beverage during manufacturing. In a further embodiment of the invention, the inositol phosphate composition may be deposited into said foodstuff or beverage prior to consumption. In yet another embodiment of the invention, the combined amount of inositol hexaphosphate and inositol may be sufficient to prevent or slow progression of dental erosion or osteoporosis in a subject in need of such treatment. In another embodiment of the invention, the inositol hexaphosphate may comprise an inositol hexaphosphate salt. In another embodiment of the invention, the inositol hexaphosphate salt may consist essentially of sodium inositol hexaphosphate. In a further embodiment of the invention, the inositol hexaphosphate salt may consist essentially of potassium inositol hexaphosphate. In yet a further embodiment of the invention, the inositol hexaphosphate salt may consist essentially of calcium-magnesium inositol hexaphosphate.

A. IP₆ & Inositol in the Prevention of Tooth Decay and Erosion

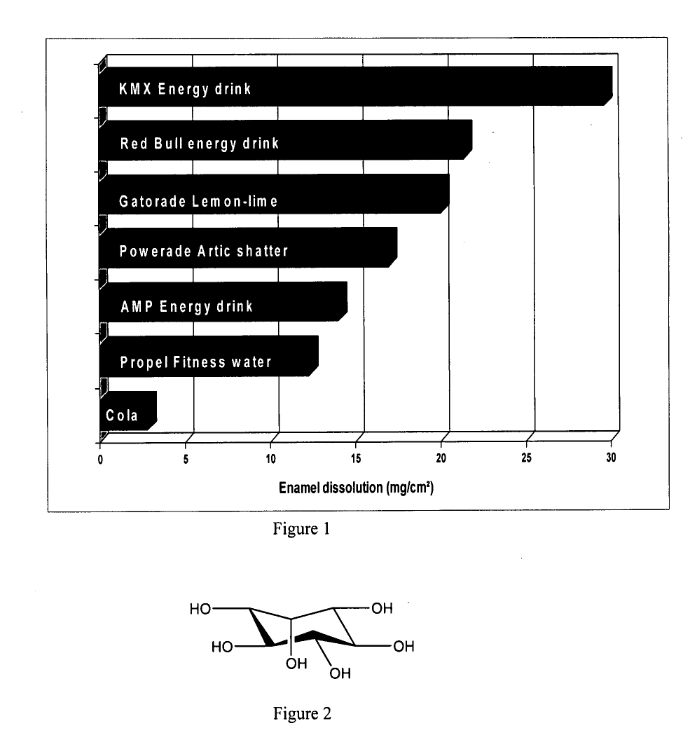

In the present invention, we have demonstrated that inositol as well as its derivatives inositol hexaphosphoric acid and/or its salts and/or esters are effective in neutralizing the free acid in citrus-based soft drinks. The chemical composition of inositol is reproduced in FIG. 2.

The results were demonstrated in the titratable acidity of a variety beverages and measuring the % TA of beverages following the addition of Ca-Mg IP-6 plus inositol, and sodium IP-6.

Titratable (total) acidity measures the total or potential acidity and indicates the total number of acid molecules, whereas a pH measurement represents the hydrogen ion concentration. The titratable acidity (as % citric acid) is calculated by titrating the beverage against sodium hydroxide (NaOH) solution to pH 8.2 and using the following relationship:

$$TA ( \% citric acid ) = \frac{( ml of 1 N NaOH ) \times Equivalent weight of citric acid}{10 \times ( weight of sample )}$$

in accordance with the standard procedures for determining the titratable acidity of a variety of fluids, including milk.

In one embodiment of the present invention, a decrease in titratable acidity may be measured by a reduction in % TA. A decrease in titratable acidity may include any reduction in the % TA. In some embodiments of the present invention, the reduction in the % TA is over 0% and up to and including 100%, preferably 10% to 100%, and more preferably 50% to 100%.

As discussed above, soft drinks contain various acidulants to enhance their flavor. These are phosphoric acid and various polybasic organic acids.

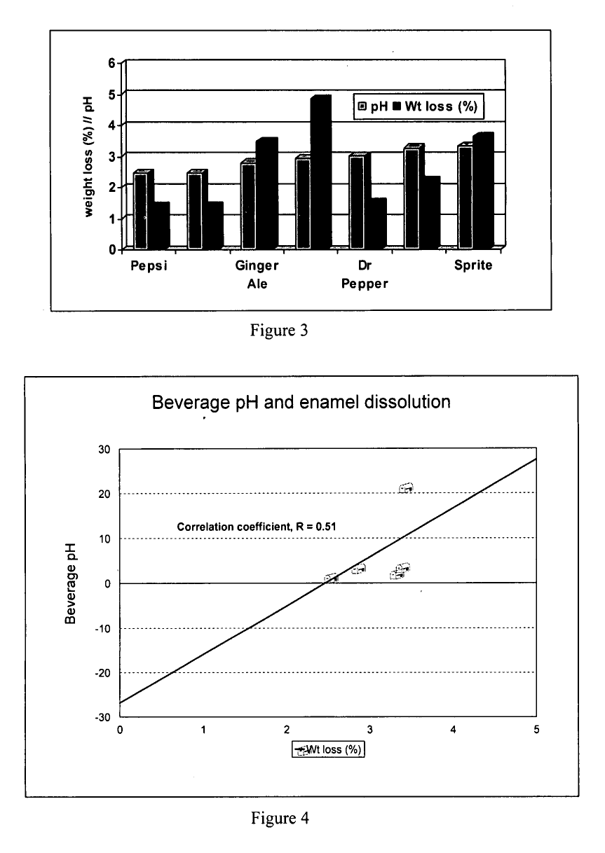

Studies show that there is no correlation between the pH of the beverage and enamel attack. FIGS. 3 and 4 show the rate of enamel dissolution in various soft drinks and the pH of the beverages.

For instance, studies were performed on sections of enamel removed from extracted human teeth as well as on extracted human teeth that were coated such that only the crown of the tooth (the enamel portion) was exposed to the beverage.

TABLE 1
Beverage pH and % TA (citric acid)

| Soft drink | Mean pH | % TA |
|---|---|---|
| A&W Root Beer | 4.49 | 0.22 |
| Bart's Root Beer | 4.16 | 0.33 |
| Canada Dry Ginger Ale | 3.01 | 0.35 |
| Coca Cola | 2.62 | 0.16 |
| Diet Coke | 3.37 | 0.33 |
| Dr Pepper | 3.16 | 0.36 |
| Fresca | 3.19 | 0.27 |
| Gatorade Lemon-Lime | 3.09 | 0.24 |
| Mountain Dew | 3.32 | 0.29 |
| Red Bull | 3.38 | 0.74 |
| Sprite | 3.37 | 0.45 |
| Tap water | 7.28 | 0.00 |

As shown in Table 1, there was no correlation between beverage pH and titratable acidity and this finding clearly supports that % TA was a more accurate reflection of beverage-induced dental enamel dissolution. It was also noted that newly-opened beverage containers had a higher % TA than those that had been opened and exposed to the atmosphere; this effect was presumably the result of absorption of atmospheric CO₂ or release of effervescence within the beverage.

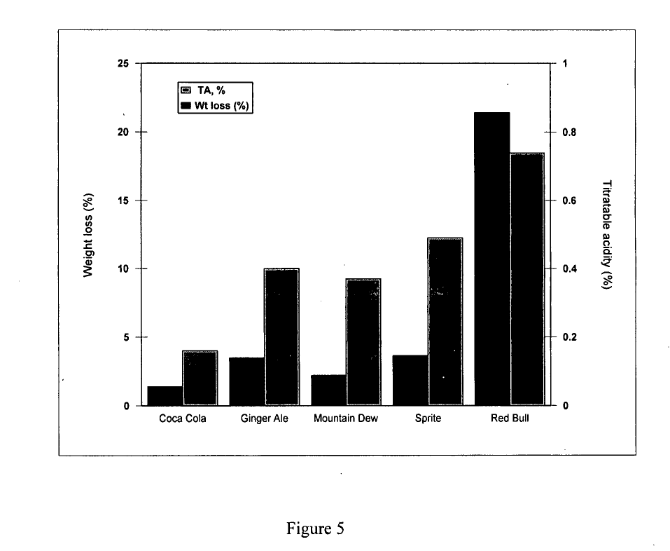

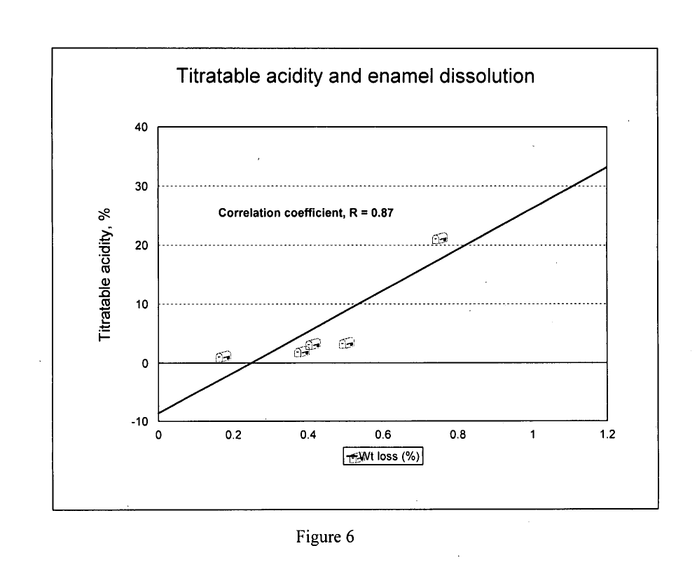

As previously stated, the beverage pH is the immediate or actual acidity and is a measure of hydrogen ion concentration. In contrast, the titratable acidity (TA) is the total or potential acidity and indicates total number of acid molecules (both protonated and unprotonated). Studies show that there is a very strong correlation between titratable acidity and enamel dissolution as demonstrated by FIGS. 5 and 6.

The answer to minimizing enamel erosion is to reduce the titratable acidity. The reason that polybasic organic acids are erosive to enamel include their ability to chelate calcium, their good buffering capacity, their ability to maintain the pH below threshold value and the fact that marked dilution has little effect on buffering.

Our studies indicate that the addition of dodecasodium inositol hexaphosphate (IP₆) and calcium-magnesium salt of IP₆ and inositol reduced the % TA of soft drinks:

TABLE 2
Effect of IP₆ and Inositol on % TA Reduction in Soft Drinks

% TA

| | Red Bull | Fresca |
|---|---|---|
| Beverage alone | 1.04 | 0.46 |
| Addition of 0.5 g Ca—Mg IP6 + Inositol | 0.79 | 0.34 |
| Addition of 1 g of Na-IP6 | 0.22 | 0.0 |

Subsequent studies have shown that additions of IP₆ and inositol to a variety of beverages, including Fresca and Red Bull, reduce the % TA to close to 0. IP₆ alone provides even better protection than a combination of IP₆ and inositol. Though this invention is not limited to using IP₆ alone. These experiments were conducted with a 1:1 molar ratio of IP₆ and inositol.

These data demonstrate that inositol and its derivatives reduced the titratable acidity of beverages and confirm that the reduction of potential beverage acidity prevent dental enamel degeneration.

Further demonstrating this, studies were performed on extracted human teeth, either on sections of enamel dissected off the crowns or intact teeth with the root portion of the teeth beneath the enamel/dentin junction coated with protective varnish. These enamel specimens were immersed in the various soft drinks with or without additions of 0.5 and 1.0% by weight of dodecasodium salt of phytic acid (Inositol hexaphosphoric acid).

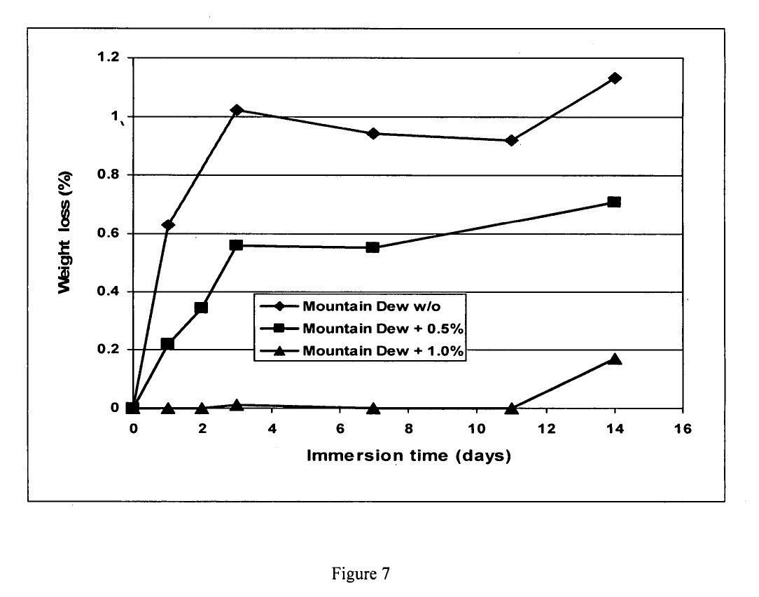

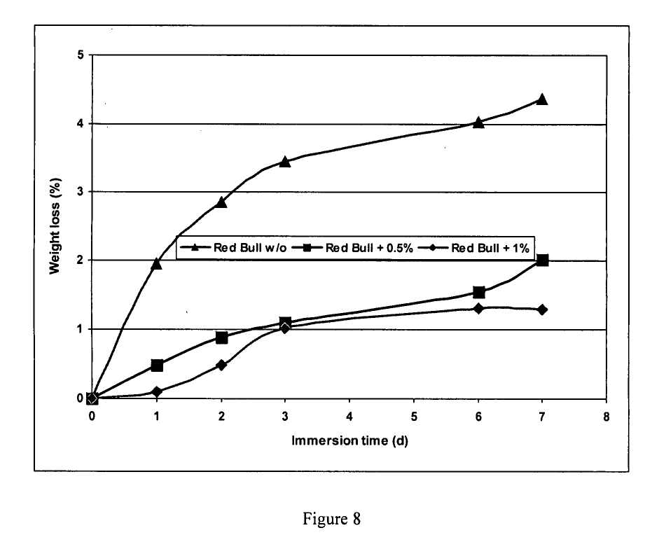

The enamel dissolution was determined as the weight loss of the enamel at different time intervals in the untreated and treated beverages, as shown in FIGS. 7 and 8.

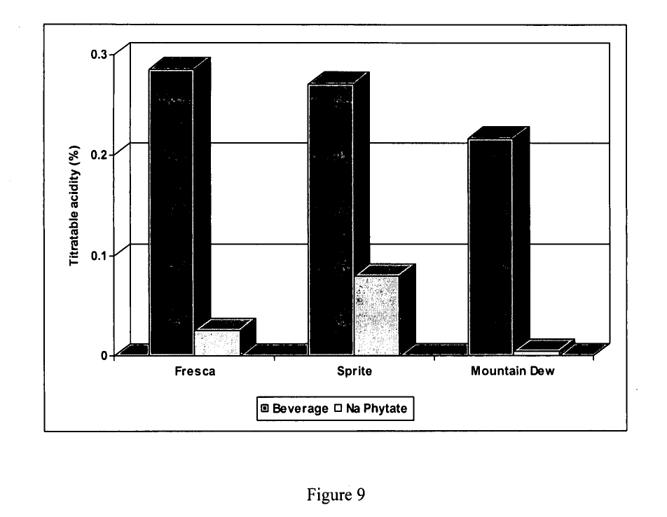

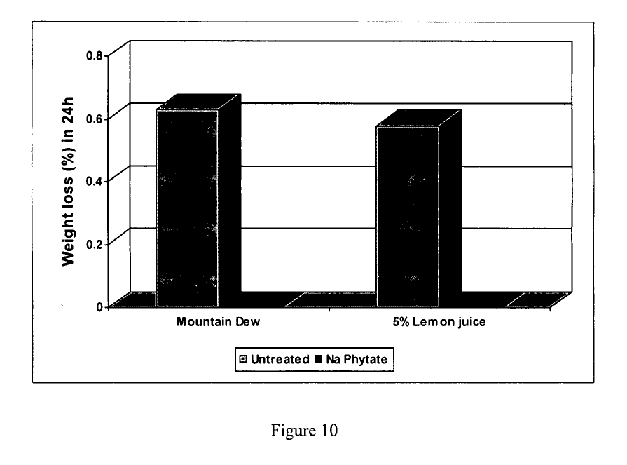

The conclusion that phytic acid reduces enamel erosion in citric acid-containing beverages by reducing the titratable acidity is therefore demonstrated by the results presented in FIGS. 8 and 9.

In view of this, potential applications, as discussed, include an additive for citric acid containing beverages, additives for dentifrices and use of the additive in foodstuffs or beverages by xerostomic patients or those with diminished salivary secretions or capacity.

B. IP₆ & Inositol in Prevention of Osteoporosis

Human osteoblast MG-63 cells and HS-883 osteoclast cells were treated with IP₆ in vitro and their abilities to proliferate and differentiate were evaluated by MTT-based cytotoxicity assay (for proliferation) and alkaline phosphatase (ALP) and matrixmetalloproteinase-2 (MMP-2), activity for differentiation of bone cells. IP₆ activates ALP and MMP-2 expression in osteoblast cells, indicating their better ability to lay new bone. On the other hand, IP₆ suppresses the proliferation of bone destroying osteoclast cells.

TABLE 3
Effect of IP₆ and Inositol on Prevention of Osteoporosis

| Hydrocortisone | Control | IP₆ Treatment |
|---|---|---|
| None | 0.52 ± 0.01 | 0.34 ± 0.02 |
| 10 μM | 0.59 ± 0.04 | 0.45 ± 0.02 |

Data represents mean ± SD of absorbance at 540 nm of HS-883 osteoclast cells treated with 300 μM Na-IP₆ + 70 μM inositol. This suppression of osteoclast cells by IP₆ is significant at p < 0.05.

In an additional study, osteoblast MG-63 human osteosarcoma cells and osteoclast HS-883.T human bone giant sarcoma cells were cultured in Eagle's Minimum Essential Medium, in Eagle's Balanced Salt Solution with non-essential amino-acids and Dulbecco's Modified Eagles Medium, respectively. Both media were supplemented with 10% fetal bovine serum (FBS) and L-glutamine. Additionally, 1 mM of sodium pyruvate was added to culture media for MG-63 cells.

Stock solution of 100 mM Na-IP6 was prepared in distilled water, pH adjusted to 7.4, and diluted as needed in culture media.

Cell growth and proliferation were determined with the MTT-based cytotoxicity assay. Briefly, the MG-63 and HS-883.T cell lines were seeded into 96-well plates at a density 2000 cells per well. Twenty-four hours later, the cells were exposed to different concentrations of IP6, ranging from 50 to 300 μM, hydrocortisone 10 μM and combinations of hydrocortisone with IP6. Cells were allowed to proliferate for 24 or 72 hours. 100 μL of MTT solution at concentration I mg/ml was added at the end of proliferation period to each well and allowed to incubate for 4 hours. The formazan product of MTT reduction was dissolved by adding 150 μL of DMSO. Immediately after, growth changes were evaluated by recording the reduction of MTT at 540 nm in a plate reader using data reduction software for measurement of optical density.

To study the osteoblast and osteoclast differentiation in the presence of IP6, the following markers were evaluated: alkaline phosphatase (ALP), matrix metalloproteinase-2 (MMP-2) and tartrate-resistant acid phosphatase (TRAP).

ALP activity was measured using a commercially available kit. Osteoblast cells were plated in tissue culture dishes in amount of 4×105 cells per plate. When the cells reached about 50-60% confluence, they were treated with different concentrations of IP6, hydrocortisone 10 μM or hydrocortisone +IP6, 50 μM for 48 hours. Incubation was stopped on ice; cells were washed twice with PBS and lysed with 0.25% of Triton X-100. 25 μL of lysate was mixed with 2.5 mL of ALP sample buffer, incubated for 4 or 24 hours in room temperature and absorption was read in a plate reader at λ405 nm.

TRAP has been determined by similar procedure. Osteoclasts were plated at 6×105 cells per plate. For enzyme evaluation 200 μL of lysate was mixed with 60 μL of L-tartrate solution and 3 mL of reagent. The results were adjusted for the amount of proteins.

To evaluate MMPs activity in culture medium zymography was performed. Cells were plated in tissue culture dishes, allowed to grow to 60 -70% confluence and then were treated with different concentrations of IP6 in serum free media. After 48 hours conditioned media was collected and immediately analyzed for matrix metalloproteinase activity. 10% Polyacrilamide gels were used to perform electrophoresis, following which gels were incubated in renaturating buffer for 30 minutes with gentle agitation. Incubation was continued in developing buffer overnight at 37° C. At the end of incubation time gels were stained with Comassie blue staining solution for 10 minutes, rinsed with destaining solution one (9.2% acetic acid, 45.4% methanol) and incubated with destaining solution two (10% acetic acid and 10% methanol) at room temperature as needed. Proteinase activity was measured using UN-SCAN-IT gel digitizing software for Windows and expressed as percentage according to the amount of determined Pixel average for each band.

TABLE 4
Effects of IP6 and Inositol on Prevention of Osteoporosis
Proliferation of MG-63 osteoblast treated
with IP6 and 10 μM hydrocortisone.

| IP₆ Treatment | Control | Hydrocortisone |
|---|---|---|
| None | 1.54 ± 0.12 | 1.07 ± 0.14 |
| IP₆ 50 μM | 1.69 ± 0.09 | 1.73 ± 0.03 |
| Data represents mean ± SD of absorbance at 540 nM of MG-63 human osteoblast cells treated with Na-IP₆ 50 μM + 70 μM inositol. Note that hydrocortisone significantly (p < 0.05) reduced the number of bone-forming | | |
| # osteoblast cells by 30.5% and treatment with IP₆ + Inositol reversed that suppression of osteoblast growth (also significant at p < 0.05) | | |

By zymography, active gelatinase-A was barely detectable in culture media from control group of cells. However, it was detected in significant quantities in media from cells cultured with IP₆ in concentration range between 50 to 300 μM. IP₆ increased the activity of gelatinase A in the culture media from osteoblast cells in dose-dependent manner. Significant increase of activity was observed after treatment of cells with 300 μM of IP₆. Conversely, decrease of both pro-MMP-2 and MMP-2 activity was observed in bone destroying osteoclast cells treated with 100 and 300 μM of IP₆.

In addition, it is found that IP₆ opposes the negative effect of hydrocortisone (a commonly used steroid that induces osteoporosis in its users) on osteoblast cell proliferation. These experiments were conducted with 50-300 μM sodium salt of IP₆ and 70 μM inositol; thus, the molar ratios of IP₆ and inositol are about 1:1.4 to about 4.3:1.

In summary, IP₆ and/or inositol has demonstrated the capability of preventing tooth decay, tooth erosion, as well as metabolic/degenerative diseases of the bone; various salts of IP₆ such as sodium, and calcium-magnesium were all effective. In addition, phytic acid with or without inositol decreases osteoporosis.

It is to be noted that, in a preferred embodiment, the salts to be used are the calcium or calcium-magnesium salt of IP₆ which provide the added calcium needed by osteoporosis patients. In addition, the molar ratios of IP₆ and inositol ranged from 1:1.4 to 4.3:1.

While the invention has been described by way of examples and in terms of the preferred embodiments, it is to be understood that the invention is not limited to the disclosed embodiments. On the contrary, it is intended to cover various modifications as would be apparent to those skilled in the art. Therefore, the scope of the appended claims should be accorded the broadest interpretation so as to encompass all such modifications.

We claim:

1. A method comprising the steps of depositing an inositol phosphate composition into a foodstuff or beverage, thereby decreasing the titratable acidity of said foodstuff or beverage.

2. A method according to claim 1, wherein said inositol phosphate composition comprises an inositol phosphate having 1-6 phosphate groups.

3. A method according to claim 1, wherein said inositol phosphate composition comprises an inositol phosphate salt.

4. A method according to claim 3, wherein said inositol phosphate salt is selected from a group consisting essentially of: potassium, calcium, magnesium, calcium-magnesium, and sodium inositol phosphate salts.

5. A method according to claim 2, wherein said inositol phosphate composition having 1-6 phosphate groups comprises an inositol phosphate salt.

6. A method according to claim 5, wherein said inositol phosphate salt consists essentially of: potassium, calcium, magnesium, calcium-magnesium, or sodium inositol phosphate salts.

7. A method according to claim 1, wherein said inositol phosphate composition is deposited into said foodstuff or beverage during manufacturing.

8. A method according to claim 1, wherein said inositol phosphate composition is deposited into said foodstuff or beverage prior to consumption.

9. A composition comprising inositol hexaphosphate and inositol, wherein the combined amount of inositol hexaphosphate and inositol is sufficient to prevent or slow progression of dental erosion or osteoporosis in a subject in need of such treatment.

10. The composition of claim 9, wherein said inositol hexaphosphate comprises an inositol hexaphosphate salt.

11. The composition of claim 10, wherein said inositol hexaphosphate salt consists essentially of sodium inositol hexaphosphate.

12. The composition of claim 10, wherein said inositol hexaphosphate salt consists essentially of potassium inositol hexaphosphate.

13. A method comprising administering to a mammal a pharmaceutical composition comprising inositol hexaphosphate in an amount sufficient to prevent, slow progression or inhibit osteoporosis.

14. A method according to claim 13, wherein said inositol hexaphosphate comprises an inositol hexaphosphate salt.

15. A method according to claim 14, wherein said inositol hexaphosphate salt consists essentially of potassium inositol hexaphosphate.

16. A method according to claim 13, wherein said pharmaceutical composition further comprises inositol.

17. A method according to claim 16, wherein said inositol hexaphosphate salt consists essentially of calcium-magnesium inositol hexaphosphate.

18. A method according to claim 14, wherein said inositol hexaphosphate salt consists essentially of calcium-magnesium inositol hexaphosphate.
